(19) United States
(12) Patent Application Publication
(10) Pub. No.: US 2005/0022622 A1
(43) Pub. Date: Feb. 3, 2005

(54) Shifter with dampened pawl movement

(76) Inventor: David M. Mitteer, Shelby, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/629,503

(22) Filed: Jul. 29, 2003

(51) Int. Cl. B60K 3/00

(52) U.S. Cl. 74/473.3

(57) ABSTRACT

A shift mechanism including a base, and a shift gate having a plurality of notches defining gear positions. A shift lever is movably mounted to the base. The shift mechanism includes a pawl configured to move between an engaged position wherein the pawl engages the shift gate and restricts movement of the shift member, and a disengaged position. The pawl is biased into the engaged position. The shift mechanism further includes a linkage disposed in the shift lever and coupled to the pawl for shifting the pawl between the engaged and disengaged positions. A button on the shift lever is operably connected to the linkage such that the button can be pushed to selectively move the pawl from the engaged position to the disengaged position. The shift mechanism also includes a pneumatic mechanism providing a first resistance against movement of the pawl in a first direction from the engaged position to the disengaged position, and also provides a second resistance against movement of the pawl in a second direction from the disengaged position to the engaged position, the second resistance being greater than the first.

### BACKGROUND OF THE INVENTION

Shifters for automatic transmissions of motor vehicles commonly include a pawl that engages detents in a shift gate to restrict movement of the shift lever. A push button on the shift knob controls release of the pawl, such that a user will, for example, need to depress the release button to move the shift lever from PARK to another gear position such as NEUTRAL or DRIVE. Similarly, the geometry of the detents on the shift gate also prevents movement of the shift lever into PARK without first depressing the release button.

The release button in known shifters is mechanically coupled to the pawl, such that depression of the release button shifts the pawl to a released or disengaged position permitting movement of the shift lever. However, the mechanical linkage may be rather complicated and expensive to manufacture. Also, the space requirements for the linkage limits the design configurations of the shift lever and knob. Furthermore, the operation of the pawl may create noise due to contact of the pawl with the detent gates.

### SUMMARY OF THE INVENTION

One aspect of the present invention is a shift mechanism including a base, and a shift gate having a plurality of notches defining gear positions. A shift lever is movably mounted to the base. The shift mechanism includes a pawl configured to move between an engaged position wherein the pawl engages the shift gate and restricts movement of the shift member, and a disengaged position. The pawl is biased into the engaged position. The shift mechanism further includes a linkage disposed in the shift lever and coupled to the pawl for shifting the pawl between the engaged and disengaged positions. A button on the shift lever is operably connected to the linkage such that the button can be pushed to selectively move the pawl from the engaged position to the disengaged position. The shift mechanism also includes a pneumatic mechanism providing a first resistance against movement of the pawl in a first direction from the engaged position to the disengaged position, and also provides a second resistance against movement of the pawl in a second direction from the disengaged position to the engaged position, the second resistance being greater than the first.

Another aspect of the present invention is a pawl release mechanism for a shifter including a shift knob having a cavity defining a sidewall, and a plunger having at least a first end portion movably disposed in the cavity. The first end portion includes an annular groove defining a base wall. The first end portion has a passageway extending from the annular groove away from the first end portion. The pawl release mechanism further includes a resilient ring in the annular groove, and the annular ring has an outer peripheral edge sealingly engaging the sidewall. The resilient ring further includes an inner edge engaging the base wall of the annular groove, and the resilient ring is configured to shift within the annular groove to close off the passageway upon movement of the plunger.

Another aspect of the present invention is a shift mechanism for automatic transmissions including a base having a gate with a plurality of detent gates. A shift lever is movably mounted to the base, and the shift lever has an elongated cavity and a knob mounted to a first end of the shift lever. The knob includes a release button. The shift mechanism includes a pawl movably mounted on the shift lever and engagable with the detent gates to restrict movement of the shift lever. The pawl is biased into engagement with the detent gates. A rod is movably disposed in the elongated cavity, and the rod is operably connected with the pawl and with the release button such that manipulation of the release button selectively releases the pawl. The rod has an annular groove and a ring-like resilient member disposed in the annular groove. The rod has a passageway in fluid communication with the annular groove such that the resilient member shifts within the annular groove upon movement of the rod to control fluid flow through the passageway and the amount of force required to move the rod.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a shift mechanism including a pawl air damper according to the present invention;

FIG. 2 is a partially schematic, exploded perspective view of the shifter of FIG. 1;

FIG. 3 is a perspective view of the release button of FIG. 2;

FIG. 4 is a fragmentary, cross-sectional view of the shift knob of FIG. 3;

FIG. 5 is a cross sectional view of a shifter according to the present invention including an air damper in the shift knob;

FIG. 6 is a fragmentary view of the knob of FIG. 3 showing the release button in the non-depressed position;

FIG. 7 is a fragmentary view of the shift knob of FIG. 3 showing the release button in the depressed position;

FIG. 8 is a cross-sectional view of a shift mechanism according to another aspect of the present invention, including an air damper in the shift lever;

FIG. 9 is a fragmentary, cross-sectional view of the air damper of FIG. 8;

FIG. 10 is a cross-sectional view of another embodiment of the lever-mounted air damper; and

FIG. 11 is a cross-sectional view of yet another embodiment of the lever-mounted air damper.

### DETAILED DESCRIPTION OF PREFERRED EMBODIMENT

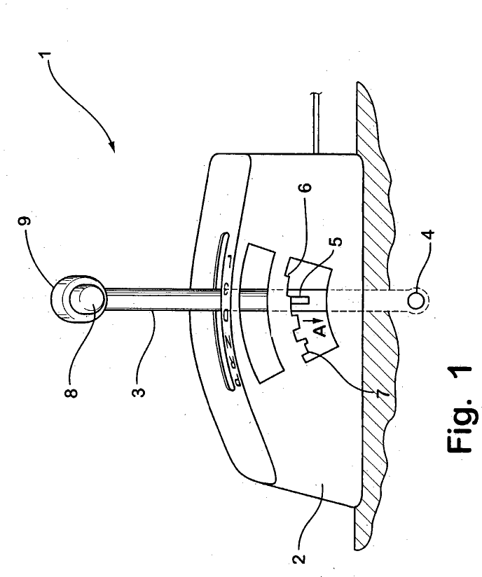

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a shift mechanism 1 according to the present invention includes a base 2 configured to be mounted to a motor vehicle such as an automobile, truck, or the like. A shift lever 3 is movably mounted to the base 2, and pivots about a joint 4. A shift gate 6 includes a plurality of notches or gate detents 7 corresponding to the gear positions P, R, N, D, 3 and L to provide controlled restriction of the movement of shift lever 3. As described in more detail below, a release button 8 on shift knob 9 is operably coupled to the pawl 5, such that the pawl 5 shifts in the direction of the arrow “A” when the release button 8 is depressed to thereby disengage the pawl 5 from the shift gate 6.

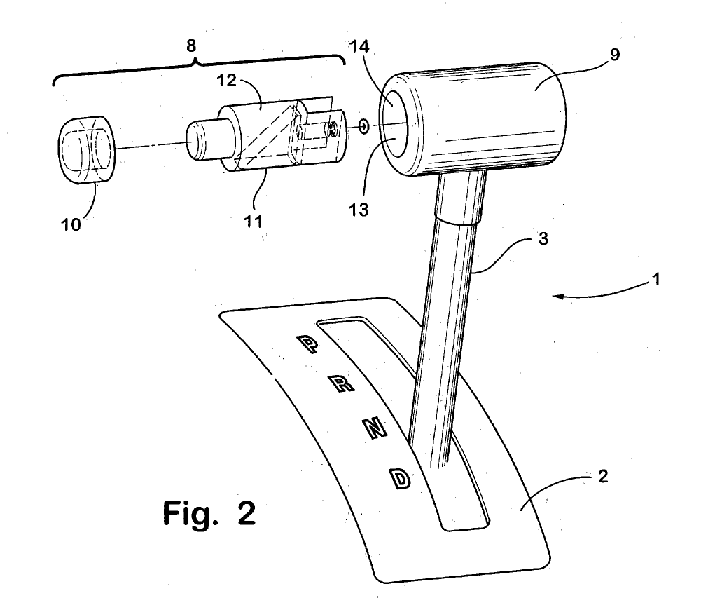

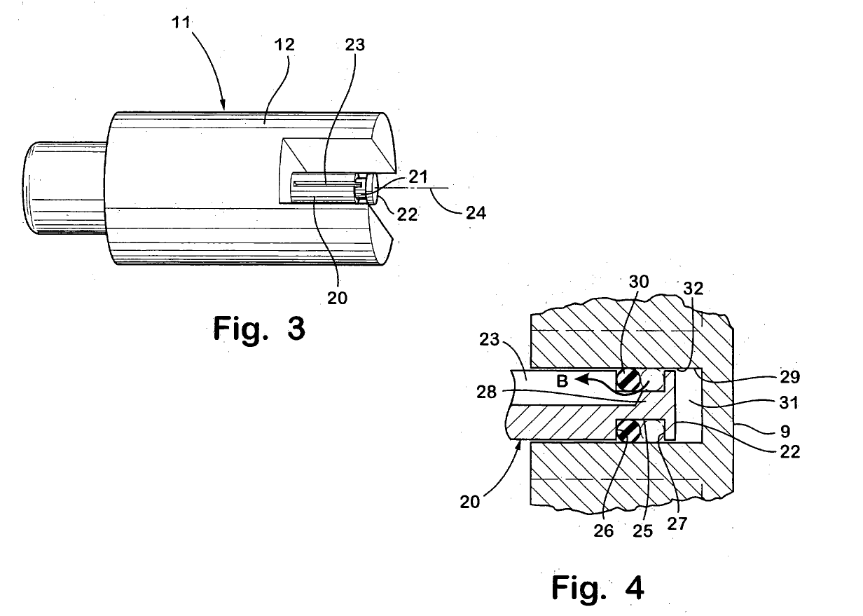

With further reference to FIG. 2, release button 8 includes an outer member 10 providing a desired appearance. The outer member 10 is secured to an inner member 11 having a generally cylindrical outer surface 12 that slidingly engages the sidewall 13 of cavity 14 in shift knob 9. With further reference to FIGS. 3 and 4, inner member 11 includes an extension 20 having a generally cylindrical shape. An annular groove 21 is formed near the end 22 of extension 20, and a longitudinal groove 23 extends generally parallel to the axis 24 of the extension 20. The annular groove 21 includes a base wall 25, and sidewalls 26 and 27.

A resilient O-ring 30 is made of an elastomeric material, and is positioned in the annular groove 21. The O-ring 30 seals against the base wall 25 of annular groove 21, and also sealingly engages the cylindrical sidewall 29 of cavity 31 formed in knob 9. The groove 23 terminates at an end portion 28 to provide selective metering of fluid flow through the groove 23.

During operation, when a user pushes the button 8 inwardly, the O-ring 30 will shift to the position illustrated in FIG. 4. As the button is moved inwardly, the air in cavity 31 passes through the gap 32 formed between the end 22 of extension 20, and through the groove 23 as illustrated by the arrow “B”. As described in more detail below, the button 8 is biased to the outward position by a spring or the like. Thus, upon release of button 8 by a user, the button 8 will shift outwardly. As the button 8 moves, the O-ring 30 will shift within annular groove 21 until it contacts the second sidewall 27 of annular groove 21. In this position, the O-ring seals against the base wall 25 of annular groove 21, and prevents airflow into the longitudinal groove 23. Thus, a vacuum is formed in the cavity 31 to provide a controlled resistance to outward movement of the button 8.

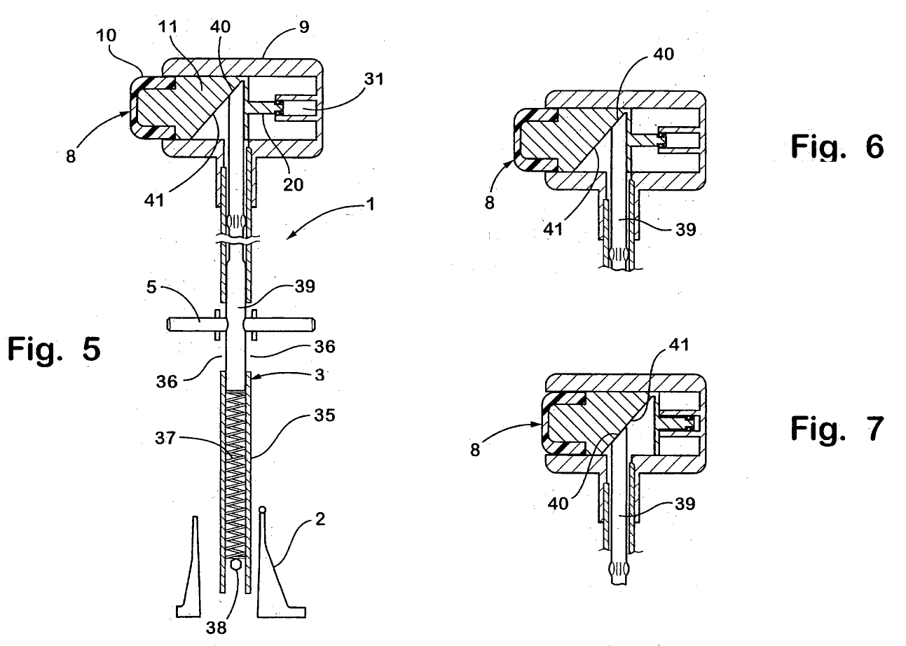

With further reference to FIG. 5, shift lever 3 includes an outer tubular member 35 having slots 36 that provide for vertical movement of pawl member 5. A spring 37 is positioned within the tubular member 35, and abuts a stop pin 38 or the like. Pawl 5 is mounted on an elongated inner member 39 that is biased upwardly by the spring 37. Inner member 39 includes an angled upper end 40 that slidingly abuts an angled wedge surface 41 formed in inner member 11 of release button 8. During operation, a user pushes on the release button 8, shifting the button 8 from the position illustrated in FIG. 6 to the position illustrated in FIG. 7. As the button 8 shifts inwardly, the end 40 of elongated inner member 39 slides along the angled wedge surface 41, thereby pushing the elongated member 39 downwardly. The pawl 5 is connected to the inner member 39, such that the pawl 5 is shifted downwardly, out of engagement with the shift gate 6 (see also FIG. 1).

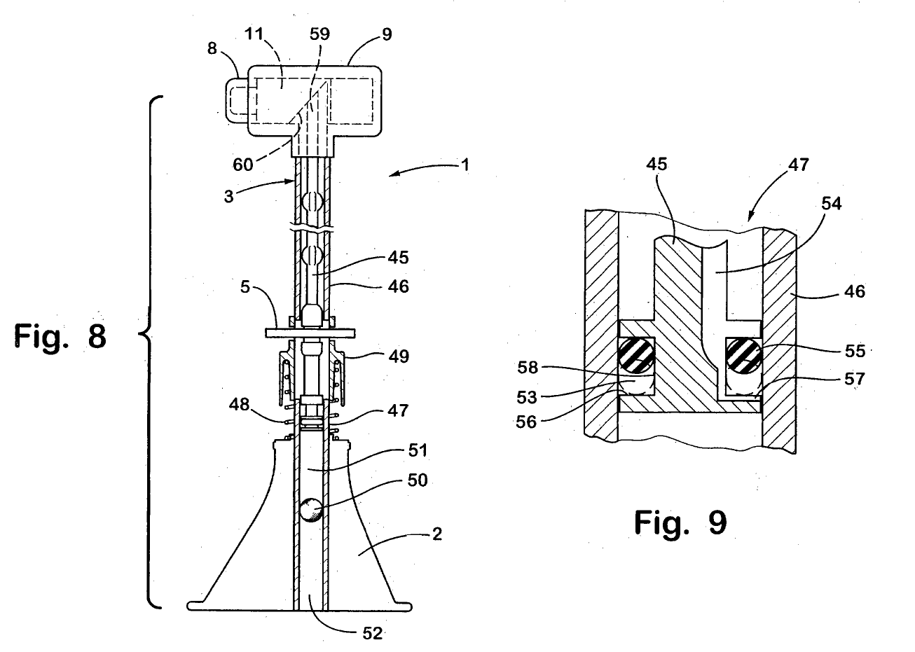

With further reference to FIG. 8, shifter 1 may include a pneumatic damper 47 in the shift lever 3. In the embodiment illustrated in FIG. 8, an elongated inner member 45 is positioned within a tubular outer member 46 of shift lever 3, and a pawl member 5 is secured to the inner member 45. A spring 48 engages a collar 49 in base 2, to thereby bias the inner member 45 and pawl member 5 upwardly. A plug member 50 positioned in the lower end of tubular member 46 seals off the lower end 52 of the tubular member 46, thereby forming a cavity 51. With further reference to FIG. 9, the pneumatic damper 47 includes an annular groove 53 formed in the end of the inner member 45, and an axial groove 54 that extends to the annular groove 53. A resilient O-ring 55 is positioned within the annular groove 53, and shifts within the groove 53 depending upon the direction of travel of the inner member 54. As the inner member 54 is shifted downwardly due to an operator pushing on the release button 8, the O-ring 55 shifts to the position illustrated in FIG. 9, and fluid (e.g. air) moves from the chamber 51 through the axial groove 54 as shown by arrow “C”, such that the push rod 45 can be moved downwardly relatively easily. When an operator releases the button 8, the spring 48 pushes the rod 45 upwardly. The O-ring 55 then shifts downwardly into contact with the sidewall 56 of annular groove 53. A small groove 57 in sidewall 56 and base wall 58 provides a small opening or orifice for air to escape around the O-ring 55, providing a resistance force against upward movement of member 45. Thus, the inner member 45 will shift upwardly at a controlled rate due to the force of spring 48, thereby pushing release button 8 outwardly as the end 59 of rod 45 contacts the angled wedge surface 60 of member 11 of button 8. The size of the grooves 57 and 54 can be selected to provide the desired degree of dampening to provide a desired “feel” for a particular application. The shifter may include only the pneumatic damper 47 in the shift lever 3, or may include only the pneumatic damper in the shift knob 9, or may include a pneumatic damper in both the shift lever 3 and knob 9 if desired for a particular application. Also, the groove 57 may be varied in size as required to provide the desired rate of return of the buttons to its outer position. Still further, if required for a particular application, groove 57 may be eliminated altogether, such that O-ring 55 seals tightly against wall 56, thereby forming a vacuum in chamber 51 tending to bias member 45 downwardly.

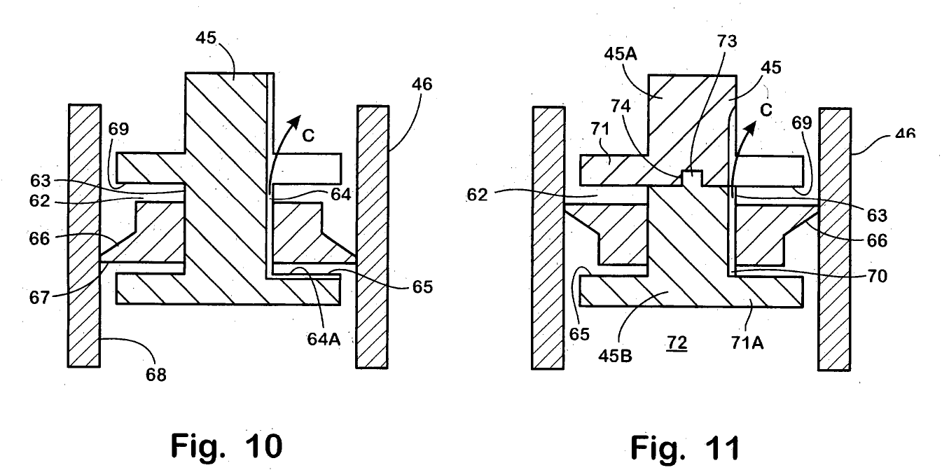

With further reference to FIG. 10, another embodiment of an air damper includes an annular groove 62 formed at the end of inner member 45. A groove 64 extends along the base wall 63, and includes a smaller groove 64A forming an orifice extending radially outwardly along sidewall 65. A resilient ring-like member 66 includes a tapered edge portion 67 that engages the inner surface 68 of tubular outer member 46 to provide a seal. During operation, as the inner member 45 is shifted downwardly, the resilient ring-like member 66 shifts into contact with the sidewall 69 of annular groove 62, and the air is vented through the groove 64. Groove 64 is relatively large such that air travels relatively unrestricted in the direction of arrow “C”, and inner member 45 can therefore be moved downwardly with relatively little force restricting the movement thereof. When the button 8 is released; the member 45 shifts upwardly, and the resilient member 66 shifts into contact with sidewall 65. The groove 64A extending along sidewall 65 provides for controlled metering of air and a desired degree of damping to slow the upward movement of inner member 45. The cross sectional area of the groove 64 extending along the sidewall 65 can be varied to provide the desired degree of dampening. Alternately, if required for a particular application, groove 64A could be eliminated such that a vacuum tending to pull member 45 downwardly is formed.

With further reference to FIG. 11, in another embodiment, ring-like member 66 is positioned in annular groove 62 in an opposite orientation relative to the arrangement of FIG. 10. A relatively large groove 70 extends along the base wall 63 of annular groove 62, and through the disk like portion 71. During operation, as the member 45 is shifted downwardly, the ring-like member 66 shifts upwardly into contact with the sidewall 69, and air passes through groove 70 as indicated by arrow “C”. Groove 70 is relatively large, such that member 45 can be moved downwardly with little or no resistance. When the release button 8 is released, the spring 48 shifts the member 45 upwardly, and the ring-like member 66 shifts downwardly into contact with sidewall 65 of annular groove 62. The resilient member 66 seals against wall 65, thereby forming a vacuum in chamber 72 tending to bias member 45 downwardly. In the illustrated embodiment, member 45 includes an upper piece 45A and a lower piece 45B. A pin 73 on piece 45B is received in cavity 74 of piece 45B, and the two parts are bonded together. The pneumatic dampers illustrated in FIGS. 10 and 11 may be utilized in either the shift lever 3, or within the shift knob 9 if required for a particular application.

The pneumatic dampers of the present invention provide for a controlled return of the push button 8 to the outer position, and thereby eliminate the noise otherwise produced by the pawl 5 and/or other components. Furthermore, the air dampers can be utilized to provide controlled resistance to inward movement of the release button 8 to provide a desired feel for a given application. The pneumatic dampers are easily constructed, and provide for reliable operation in a manner that is simple and cost effective.

The pneumatic damper is illustrated as being coupled to the pawl mechanically via linkage. However, the button 8 could include an electrically actuated switch such that the button 8 is electrically coupled to an electrically actuated pawl such as the one illustrated in U.S. Provisional Application No. 60/470,609, the entire contents of which are hereby incorporated by reference.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A shift mechanism, comprising:
a base;
a shift gate having a plurality of notches defining gear positions;
a shift lever movably mounted to the base;
a pawl configured to move between an engaged position, wherein the pawl engages the shift gate and restricts movement of the shift lever, and a disengaged position;
a button on the shift lever operably connected to the pawl such that pushing of the button moves the pawl from the engaged position to the disengaged position; and
a pneumatic mechanism providing a first resistance against movement of the pawl in a first direction from the engaged position to the disengaged position, and providing a second resistance against movement of the pawl in a second direction from the disengaged position to the engaged position, the second resistance being greater than the first.

2. The shift mechanism of claim 1, including:
a linkage disposed in the shift lever and coupled to the pawl for shifting the pawl between the engaged and disengaged positions.

3. The shift mechanism of claim 2, wherein:
said pawl is biased into the engaged position.

4. The shift mechanism of claim 2, wherein:
the shift lever includes a knob, the button being positioned on the knob;
said pneumatic mechanism includes a passageway through which fluid passes as the button is depressed, the pneumatic mechanism including a movable member that selectively restricts the passageway depending upon the direction of movement of the button.

5. The shift mechanism of claim 4, wherein:
the movable member comprises a resilient ring;
the pneumatic mechanism includes an annular groove, the resilient ring disposed in the annular groove.

6. The shift mechanism of claim 5, wherein:
the pneumatic mechanism includes a cylindrical chamber in the knob and a plunger, at least a first end portion of which is slidably disposed in the cylindrical chamber, the annular groove located adjacent the first end portion of the plunger.

7. The shift mechanism of claim 6, wherein:
the plunger defines an axis along which the plunger moves;
the chamber defines a chamber sidewall;
the annular groove defines a base wall and opposed sidewalls;
the resilient ring frictionally engaging the base wall of the groove and the chamber sidewall and shifting between the sidewalls of the annular groove upon movement of the plunger in the chamber.

8. The shift mechanism of claim 7, wherein:
the plunger includes a slot extending axially from the base wall towards a second end portion of the plunger to form the passageway, the resilient ring closing off the passageway as the plunger is moved outwardly, and permitting fluid flow through the passageway as the plunger is moved inwardly.

9. The shift mechanism of claim 8, wherein:
the resilient ring comprises an O-ring.

10. A pawl release mechanism for shifters, comprising:
a shift knob having a cavity defining a sidewall;
a plunger having at least a first end portion movably disposed in the cavity, the first end portion including an annular groove defining a base wall, the first end portion having a passageway extending from the annular groove away from the first end portion; and
a resilient ring in the annular groove, the resilient ring having an outer peripheral edge sealingly engaging the sidewall, and an inner edge engaging the base wall of the annular groove, the resilient ring configured to shift within the annular groove to close off the passageway upon movement of the plunger.

11. The pawl release mechanism of claim 10, wherein:
the plunger includes a slot forming the passageway, the slot extending from the base wall of the annular groove away from the first end portion.

12. The pawl release mechanism of claim 10, wherein:
the resilient ring comprises an O-ring.

13. The pawl release mechanism of claim 10, wherein:
the cavity comprises a first cavity having a cylindrical shape and defining a first diameter;
the knob defining a second cylindrical cavity coaxial with the first cavity and defining a second diameter that is larger than the first diameter;
the plunger including a second cylindrical end portion slidably disposed in the second cavity.

14. The pawl release mechanism of claim 13, wherein:
the plunger includes a pair of spaced-apart extensions extending generally parallel to the first end portion, and having outer cylindrical surface portions contiguous with the second cylindrical end portion, wherein the first end portion is disposed between the extensions.

15. The pawl release mechanism of claim 13, wherein:
the pawl release mechanism includes a shift lever connected to the shift knob, and an axially movable link mounted in the shift lever;
the second cavity defines an axis;
the second cylindrical end portion of the plunger includes a wedge surface disposed non-orthogonal relative to the axis, the wedge surface configured to push the link axially along the shift lever.

16. A shift mechanism for automatic transmissions, comprising:
a base including a gate having a plurality of detent gates;
a shift lever movably mounted to said base, said shift lever having an elongated cavity and a knob mounted to a first end of said shift lever, said knob including a release button;
a pawl movably mounted on said shift lever and engagable with said detent gates to restrict movement of said shift lever, said pawl biased into engagement with said detent gates;
a rod movably disposed in said elongated cavity, said rod operably connected with said pawl and with said release button, such that manipulation of said release button selectively releases said pawl;
said rod having an annular groove and a ring-like resilient member disposed in said annular groove, said rod having a passageway in fluid communication with said annular groove such that said resilient member shifts within said annular groove upon movement of said rod to control fluid flow through said passageway and the amount of force required to move said rod.

17. The shift mechanism of claim 16, wherein:
said rod includes a groove forming said passageway.

18. The shift mechanism of claim 17, wherein:
said groove defines a base wall having a generally cylindrical shape, and sidewalls extending outwardly transverse from said base wall;
at least a portion of said groove extending along said base wall to permit fluid flow past said resilient member.

19. The shift mechanism of claim 18, wherein:
said groove defines a non-uniform cross sectional area having a larger first portion and a smaller second portion;
said resilient member shifting to permit fluid flow through said first portion when said rod is moved in a first direction, and shifting such that fluid flows through said smaller second portion when said rod is shifted in a second direction.

20. The shift mechanism of claim 19, wherein:
said groove extends outwardly along a first one of said sidewalls to permit fluid flow through said groove when said resilient member is seated against said first sidewall.

21. The shift mechanism of claim 20, wherein:
said release button includes an angled wedge surface engaging a first end of said rod and longitudinally shifting said rod upon movement of said release button.

22. The shift mechanism of claim 16, wherein:
said knob includes a cylindrical cavity defining sidewalls;
said release button having an end portion movably disposed in said cylindrical cavity, said end portion defining an axis and having an annular groove and a resilient O-ring disposed in said annular groove, said end portion having an axial groove extending along said axis to said annular groove, said O-ring shifting in said annular groove upon movement of said release button to selectively control fluid flow through said axial groove.

23. The shift mechanism of claim 22, wherein:
said release button is movable inwardly and outwardly;
said annular groove defines a base wall and spaced-apart sidewalls, said axial groove terminates at said base wall such that said O-ring shifts to prevent fluid flow through said axial groove when said release button is moved outwardly, and shifts to permit fluid flow through said axial groove when said release button is moved inwardly.
